(19) United States
(12) Patent Application Publication
(10) Pub. No.: US 2025/0260009 A1
(43) Pub. Date: Aug. 14, 2025

(54) CARBON-FREE CATHODES FOR LITHIUM SULFUR BATTERIES

(71) Applicant: Conamix Inc., Ithaca, NY (US)

(72) Inventors: Stephen Burkhardt, Ithaca, NY (US); Jay J. Farmer, Ithaca, NY (US)

(21) Appl. No.: 18/856,401

(22) PCT Filed: Apr. 13, 2023
(86) PCT No.: PCT/US2023/018479

§ 371 Date: Oct. 11, 2024

Related U.S. Application Data
(60) Provisional application No. 63/331,245, filed on Apr. 14, 2022.

(51) Int. Cl. H01M 4/58; H01M 4/02; H01M 4/136; H01M 4/36; H01M 4/38; H01M 10/052

(52) U.S. Cl. CPC H01M 4/5815; H01M 4/136; H01M 4/366; H01M 4/382; H01M 10/052; H01M 2004/021; H01M 2004/027; H01M 2004/028

(57) ABSTRACT

Presented herein is a cathode material for a carbon-free (including relatively carbon-free) cathode, the cathode material comprising (i) sulfur and/or a lithium sulfide and (ii) a different, non-carbon electroactive material such as a metal chalcogenide. In certain embodiments, it is found that the carbon-free cathode material facilitates improved ion transport while maintaining satisfactory mechanical stability and electrical connection of the cathode without use of conductive carbon additives.

### CROSS-REFERENCE TO RELATED APPLICATIONS

This application claims priority to and the benefit of U.S. Provisional Patent Application No. 63/331,245, filed Apr. 14, 2022, the contents of which are hereby incorporated by reference herein in their entirety.

### BACKGROUND

There is significant work being conducted to develop lithium ion batteries with high energy density, long cycle life, and low cost, particularly batteries for electric vehicles and consumer electronics.

Sulfur is a low cost, high specific energy material that is a by-product of the oil and gas industry. Sulfur-based battery cathodes have been under investigation for some time. As a high energy density cathode material, sulfur promises to eliminate the need for cobalt and nickel in lithium batteries. Cobalt is expensive, toxic, and its mining in certain regions may be subject to loose regulation and unethical practices. Nickel has high energy density, but there are long term nickel supply concerns, for example, recently motivating Tesla's shift away from nickel-containing battery cells.

Producing sulfur cathodes capable of commercial performance levels has been a challenge, for example, because sulfur by-products reduce performance and limit cycle-life, and because low density single function materials such as conductive carbon additives negatively impact the energy density of formulated sulfur cathodes.

Cathodes for lithium batteries, including lithium sulfur battery cathodes, almost always contain conductive carbon. For example, conductive graphitic additives are often introduced to enhance the mechanical stability and electronic conductivity of the cathode. However, carbon has poor lithium ion transport properties (e.g. lithium ions transport through the cathode pore network may be hindered by this carbon-containing mixed phase) and contributes no electrochemical capacity to the battery. Furthermore, because carbon has a low gravimetric density its presence significantly reduces the volumetric energy density of sulfur cathode composites. Attempts have been made to ameliorate the low ion conductivity. For example, the use of conductive carbon-sulfur films with interconnected mesopores has been investigated as an advanced cathode for lithium sulfur batteries.

However, this does not address the reduction in energy density and there remains a need for cathode compositions in lithium sulfur batteries with satisfactory mechanical stability and electrical properties that overcome the problem of lithium ion transport inhibition and reduced energy density due to a carbon-containing phase in the cathode.

### SUMMARY

The present disclosure provides, among other things, cathode materials and batteries that include the same. A cathode material may include at least one electroactive sulfur material and a non-sulfur, non-carbon material (e.g., wherein the cathode material is substantially free of carbon).

In some aspects, the present disclosure is directed to a cathode material for a carbon-free sulfur cathode, the cathode material comprising: at least one electroactive sulfur conversion cathode material; and a non-sulfur, non-carbon electroactive material, wherein the cathode material (e.g., and wherein the carbon-free cathode) contains no more than 5 wt. % (e.g., no more than 2 wt. %, no more than 1 wt. %, no more than 0.5 wt. %, or no more than 0.1 wt. %) carbon.

In some embodiments, the non-sulfur, non-carbon electroactive material is an intercalation material having a structure capable of reversibly intercalating lithium ions within a voltage range overlapping with the voltage range of sulfur conversion (e.g., from about 1.8 V to about 2.6 V, vs. Li/Li⁺ e.g., from about 2.0 V to about 2.4 V vs. Li/Li⁺).

In some embodiments, the non-sulfur, non-carbon electroactive material is a conversion material (e.g., a chalcogenide that undergoes an electrochemical conversion reaction within a voltage range overlapping with the voltage range of sulfur conversion (e.g., from about 1.8 V to about 2.6 V, vs. Li/Li⁺ e.g., from about 2.0 V to about 2.4 V vs. Li/Li⁺).

In some embodiments, the non-sulfur, non-carbon electroactive material is a chalcogenide (e.g., a metal chalcogenide, e.g., a metal sulfide).

In some embodiments, the non-sulfur, non-carbon electroactive material is also an electron conductor.

In some embodiments, the non-sulfur, non-carbon electroactive material has discharge capacity.

In some embodiments, the cathode material comprises core shell structures. In some embodiments, the cathode material comprises cores each having a surrounding shell, said cores comprising the electroactive sulfur conversion material (e.g., Li₂S₂ and/or Li₂S), and said shells comprising the non-sulfur, non-carbon electroactive material (e.g., one or more metal chalcogenides).

In some embodiments, the core shell structures have an average core diameter in a range from 50 to 300 nm, and an average shell thickness in a range from 1 to 20 nm thick (e.g., no greater than 10 nm thick).

In some embodiments, the core shell structures have at least 10 mass % non-sulfur non-carbon electroactive material (e.g., metal chalcogenide) relative to sulfur (e.g., from 10 to 90 mass % non-sulfur, non-carbon electroactive material, e.g., from 30 to 70 mass % non-sulfur, non-carbon electroactive material).

In some embodiments, the at least one electroactive sulfur conversion cathode material comprises one or more members selected from the group consisting of: sulfur in its S₈ cyclic octatonic molecular form, lithium sulfide (e.g., Li₂S₂ and/or Li₂S), an electroactive organosulfur compound, and an electroactive sulfur containing polymer.

In some aspects, the invention is directed to a cathode comprising any of the cathode materials described herein, wherein the fraction of carbon in the cathode is no more than 5 wt. % (e.g., no more than 2 wt. %, no more than 1 wt. %, no more than 0.5 wt. %, or no more than 0.1 wt. %).

In some embodiments, the cathode material is disposed in a film (e.g., that comprises a binder).

In another aspect, the invention is directed to a battery (e.g., a rechargeable battery) comprising (i) a cathode as described herein and (ii) an electrolyte in contact with the cathode.

In some embodiments, the battery further comprises an anode. In some embodiments, the anode is a protected lithium metal anode.

In some embodiments, the battery further comprises a protected current collector.

Any two or more of the features described in this specification, including in this summary section, may be combined to form implementations of the disclosure, whether specifically expressly described as a separate combination in this specification or not.

### BRIEF DESCRIPTION OF THE DRAWING

The present teachings described herein will be more fully understood from the following description of various illustrative embodiments, when read together with the accompanying drawings. It should be understood that the drawing described below is for illustration purposes only and is not intended to limit the scope of the present teachings in any way. The foregoing and other objects, aspects, features, and advantages of the disclosure will become more apparent and may be better understood by referring to the following description taken in conjunction with the accompanying drawings, in which:

FIG. 1 illustrates a cross section of an electrochemical cell 800 in accordance with exemplary embodiments of the disclosure; and

FIG. 2 illustrates an example of a battery according to various embodiments described herein.

### DEFINITIONS

About/Approximately: The term “about” or “approximately”, when used herein in reference to a value, refers to a value that is similar, in context, to the referenced value. In general, those skilled in the art, familiar with the context, will appreciate the relevant degree of variance encompassed by “about” or “approximately” in that context. For example, in some embodiments, e.g., as set forth herein, the term “about” can encompass a range of values that within 25%, 20%, 19%, 18%, 17%, 16%, 15%, 14%, 13%, 12%, 11%, 10%, 9%, 8%, 7%, 6%, 5%, 4%, 3%, 2%, 1%, or within a fraction of a percent, of the referred value.

Carbon: As used herein in connection with cathode materials, refers to elemental carbon or materials that are substantially composed of elemental carbon, examples include graphite, carbon black, graphene, carbon nanotubes and derivatives of such materials (e.g. oxidized, nitrogen-doped, or carboxylated graphene derivatives). Carbon-containing organic molecules such as hydrocarbons, polymers, solvents and the like are not encompassed by this term unless otherwise indicated. Similarly, in the context of terms such as “Carbon Free” and “Non-Carbon Materials” it is these elemental forms of carbon that are to be understood to be excluded.

Intercalation Material: As used herein, the term “intercalation material” refers to a substance into which another substance or species (e.g. ion, metal ion) is reversibly inserted or included in vacancies, interstitial sites, voids, or between layers of the intercalation material, or some combination thereof.

Electroactive Material: As used herein, the term “electroactive material” refers to a composition of matter with one or more components capable of changing its oxidation state in a charge-transfer step of an electrochemical reaction.

Lithium alloy: As used herein, the term lithium alloy refers to substances formed by combinations of lithium and other metals or semimetal elements: non-limiting examples include lithium silicon compounds, and alloys of lithium with metals such as sodium, cesium, indium, aluminum, zinc and silver.

Nanoparticle, Nanostructure, Nanomaterial: As used herein, these terms may be used interchangeably to denote a particle of nanoscale dimensions or a material having nanoscale structures. The nanoparticles can have essentially any shape or configuration, such as a tube, a wire, a laminate, sheets, lattices, a box, a core and shell, or combinations thereof.

Substantially: As used herein, the term “substantially” refers to the qualitative condition of exhibiting total or near-total extent or degree of a characteristic or property of interest.

### DETAILED DESCRIPTION OF CERTAIN EMBODIMENTS

Elements of different implementations described herein may be combined to form other implementations not specifically set forth above. Elements may be left out of the devices described herein without adversely affecting their operation. Various separate elements may be combined into one or more individual elements to perform the functions described herein.

It is contemplated that articles, devices, compositions, systems, methods, and processes of the claimed invention encompass variations and adaptations developed using information from the embodiments described herein. Adaptation and/or modification of the articles, devices, compositions, systems, methods, and processes described herein may be performed, as contemplated by this description.

Throughout the description, where articles, devices, compositions, and systems are described as having, including, or comprising specific components, or where processes and methods are described as having, including, or comprising specific steps, it is contemplated that, additionally, there are articles, devices, compositions, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The mention herein of any publication is not an admission that the publication serves as prior art with respect to any of the claims presented herein. The Background section is presented for purposes of clarity and is not meant as a description of prior art with respect to any claim.

Headers are provided for the convenience of the reader—the presence and/or placement of a header is not intended to limit the scope of the subject matter described herein.

Presented herein is a cathode material for production of a carbon-free (including relatively carbon-free) cathode, the cathode material comprising (i) a sulfur-based active material and (ii) a different, non-carbon electroactive material such as a metal chalcogenide. In certain embodiments, it is found that the carbon-free cathode material facilitates improved ion transport while maintaining satisfactory mechanical stability and electrical conductivity of the cathode without use of graphitic additives or other carbon additives.

In certain embodiments, the non-carbon electroactive material is an intercalation material capable of reversibly intercalating lithium ions in operation within a voltage range roughly corresponding to the voltage of sulfur-to-lithium-sulfide conversion (e.g., from about 1.8V to about 2.6V vs. Li/Li⁺, e.g., from about 2.0V to about 2.4V vs. Li/Li⁺). Intercalation is the process by which a mobile ion or molecule is reversibly incorporated into vacant sites in a crystal lattice of a host network. Intercalation processes are generally characterized by minimal volume change and mechanical strain during repeated insertion and extraction of ions during charge and discharge. An intercalation cathode material comprises a solid host network which can reversibly store guest ions that are inserted into and removed from the host network.

Moreover, in certain embodiments, the cathode material has a core-shell structure (e.g., nanostructure), where the cores contain the sulfur active material and where their surrounding shells contain the non-carbon electroactive material. In certain embodiments, the structures are nanoporous. In certain embodiments, the cores are have an average diameter less than about 1000 nm, less than about 500 nm, less than about 250 nm, less than about 100 nm, less than about 80 nm, less than about 70 nm, less than about 60 nm, less than about 50 nm, less than about 40 nm, less than about 30 nm, less than about 25 nm, less than about 20 nm, less than about 10 nm, or less than about 5 nm, for example, and/or the cores may have an average diameter within any range between any two of the above listed values. In certain embodiments, the cores are spherical, roughly spherical, or amorphous in shape. In certain embodiments, the cores are have an average diameter between about 50 and about 500 nm, between about 50 and about 200 nm, between about 20 and about 100 nm, between about 100 and about 300 nm, or between about 200 and about 400 nm.

In certain embodiments, the shells surrounding the cores have an average thickness less than about 1000 nm, less than about 500 nm, less than about 250 nm, less than about 100 nm, less than about 80 nm, less than about 70 nm, less than about 60 nm, less than about 50 nm, less than about 40 nm, less than about 30 nm, less than about 25 nm, less than about 20 nm, less than about 15 nm, less than about 10 nm, less than about 5 nm, less than about 3 nm, less than about 2 nm, or less than about 1 nm, for example. and/or the shells may have an average thickness within any range between any two of the above-listed values. In certain embodiments, the shells surrounding the cores have an average thickness between about 1 and about 50 nm, between about 2 and about 20 nm, between about 1 and about 10 nm, between about 10 and about 20 nm, between about 5 and about 15 nm, or between about 1 and about 5 nm.

In certain embodiments, the cores of the provided core shell particles are composed of substantially pure electroactive sulfur material. In certain embodiments, the cores comprise a composite of the electroactive sulfur material and additional materials such as inorganic solids, metals, polymers, or other non-sulfur electroactive materials. Such composites may comprise a simple physical mixture of the materials or a more complex structured composite such as a porous scaffold infused with the sulfur electroactive material.

In certain embodiments, the non-carbon electroactive shell of provided core shell particles in non-porous and/or substantially impermeable to liquids (e.g. electrolytes) and/or impermeable to sulfur or polysulfides (or to mixtures of electrolytes and polysulfides). Such an arrangement can be advantageous in that it allows electrons and lithium ions to access the electroactive sulfur core while preventing redistribution of the electroactive sulfur material in the cathode or battery.

In other embodiments, the non-carbon electroactive shell of provided core shell particles is porous and/or permeable (e.g. permeable to liquid electrolytes or their components). In certain embodiments, such permeable shells may be advantageous to ensure electrolyte contact with the electroactive sulfur and/or to prevent physical strain from volume changes within the core from rupturing or otherwise damaging the shell. In certain embodiments such shells are nano-porous; for example having pores with diameters less than 1 nm; for example, less than 0.5 nm, less than 0.4 nm, or less than 0.3 nm, or less than 0.2 nm, and/or an average pore size within any range between any two of the above-listed values. In certain embodiments, the cores and/or the shells have average pore sizes less than 1 nm; for example, less than 0.9 nm, less than 0.8 nm, less than 0.7 nm, or less than 0.6 nm, and/or an average pore size within any range between any two of the above-listed values. In certain embodiments, the pore size is measured by microscopy (e.g. TEM, SEM, or AFM).

In certain embodiments, the non-carbon electroactive material comprises one or more chalcogenides. In certain embodiments, a chalcogenide has at least one chalcogen anion (oxygen, sulfur, selenium, tellurium, or polonium anion) and at least one electropositive element. In certain embodiments, the chalcogenide may be sulfide-, selenide-, or telluride-based. In certain embodiments, the chalcogenide comprises a metal sulfide (for example a sulfide of a metal other than lithium or sodium). In certain embodiments, the one or more chalcogenides comprises a transition metal sulfide. In certain embodiments, the one or more chalcogenides comprises one or more of the following: TiS₂, LiTiS₂ (LTS), VS₂, MoS₂, Mo₆S₈, and NbSe₃. In certain embodiments, the one or more chalcogenides comprises a transition metal oxide and/or a polyanion compound. In certain embodiments, the one or more chalcogenides comprises a metal monochalcogenide having the formula MX where M is a transition metal and X is S, Se, or Te. In certain embodiments, the one or more chalcogenides comprises at least one transition metal dichalcogenide (TMD) of the formula MX₂, where M is a transition metal (e.g., Ti, V, Co, Ni, Zr, Nb, Mo, Tc, Rh, Pd, Hf, Ta, W, Re, Ir, or Pt) and where X is S, Se, or Te. In certain embodiments, the one or more chalcogenides comprises a material with a layered crystal structure (e.g., LiTiS₂, LiCoO₂, LiNiO₂, LiMnO₂, LiNi_{0.33}Mn_{0.33}Co_{0.33}O₂, LiNi_{0.8}Co_{0.15}Al_{0.05}O₂, or Li₂MnO₃), and/or a material with a spinel crystal structure (e.g., LiMn₂O₄ or LiCo₂O₄).

In certain embodiments, the non-carbon electroactive material comprises an intercalating material and/or a non-sulfur, non-carbon electroactive material. For example, in certain embodiments, the non-carbon electroactive material comprises LiFePO₄, LiMnPO₄, or LiCoPO₄ (e.g., having an olivine crystal structure), and/or LiFeSO₄F or LiVPO₄F (e.g., having a tavorite crystal structure).

In some embodiments, a lithium-sulfur battery of the present disclosure comprises a lithium anode, a sulfur-based cathode, and an electrolyte permitting ion transport between anode and cathode. In certain embodiments, described herein, an anodic portion of a battery comprises an anode and a portion of electrolyte with which it is in contact. Similarly, in certain embodiments, described herein, a cathodic portion of a battery comprises a cathode and a portion of electrolyte with which it is in contact. In certain embodiments, a battery comprises a lithium ion-permeable separator, which defines a boundary between an anodic portion and a cathodic portion. In certain embodiments, a battery comprises a case, which encloses both anodic and cathodic portions. In certain embodiments, a battery case comprises an electrically conductive anodic-end cover in electrical communication with an anode, and an electrically conductive cathodic-end cover in electrical communication with a cathode to facilitate charging and discharging via an external circuit.

### Cathode

Compositions of the present disclosure have utility in manufacture of electrochemical devices. The compositions disclosed may be porous or non-porous. Certain compositions disclosed herein would be adhered to a current collector to form cathodes for secondary sulfur batteries. While the cathodes described herein are intended to be carbon-free (including relatively carbon free, e.g., no greater than 5 wt. % carbon, no greater than 4 wt. % carbon, no greater than 3 wt. % carbon, no greater than 2 wt. % carbon, no greater than 1 wt. % carbon, or no greater than 0.5 wt. % carbon, for example), some embodiments do contain some carbon. Provided cathode compositions may comprise one or more additives such as electrically conductive particles, binders, and other functional additives typically found in battery cathode mixtures. For example, in certain embodiments, provided cathode compositions may comprise 3D structured graphene (e.g., as described in U.S. Pat. No. 11,299,397, LytEn, Inc., the text of which is incorporated herein by reference in its entirety). In certain embodiments, provided compositions have satisfactory electrical conductivity to provide a cathode with a low resistance pathway for electrons to access such manufactured cathode. In various embodiments, other additives are included in the composition to alter or otherwise enhance a cathode produced according to the principles described herein. Other cathode components include, for example, a current collector, connecting tabs, and the like.

As discussed above, in certain embodiments, the cathode composition includes a non-carbon electroactive material (e.g., an intercalation material) and a sulfur electroactive material—for example, sulfur in its Ss cyclic octatonic molecular form, in the form of lithium sulfide (e.g., Li₂S₂ and/or Li₂S), and/or in the form of an electroactive organosulfur compound or an electroactive sulfur containing polymer. In certain embodiments, the electroactive material is an intercalation material structured to intercalate lithium ions. In certain embodiments, the electroactive material operates in a voltage range overlapping with the a discharge voltage range of S₈→Li₂S (sulfur to lithium sulfide conversion), e.g., from about 1.8V to about 2.6V vs. Li/Li¹, e.g., from about 2.0V to about 2.4V vs. Li/Li¹.

In certain embodiments, the electroactive material comprises one or more chalcogenides. In certain embodiments, a chalcogenide has at least one chalcogen anion (oxygen, sulfur, selenium, tellurium, or polonium anion) and at least one electropositive element. In certain embodiments, the one or more chalcogenides may be sulfide-, selenide-, or telluride-based. In certain embodiments, the one or more chalcogenides comprises a metal sulfide. In certain embodiments, the one or more chalcogenides comprises one or more of the following: TiS₃, LiTiS₂ (LTS), MoS₂, Mo₆S₈, VS₂, TaS₂, and NbSe₃. In certain embodiments, the one or more chalcogenides comprises a transition metal oxide and/or a polyanion compound. In certain embodiments, the one or more chalcogenides comprises a metal monochalcogenide having the formula MX where M is a transition metal and X is S, Se, or Te. In certain embodiments, the one or more chalcogenides comprises at least one transition metal dichalcogenide (TMD) of the formula MX₂, where M is a transition metal (e.g., Ti, V, Co, Ni, Zr, Nb, Mo, V, Tc, Rh, Pd, Hf, Ta, W, Re, Ir, or Pt) and where X is S, Se, or Te. In certain embodiments, the one or more chalcogenides comprises a lithiated material with a layered crystal structure (e.g., TiS₂, CoO₂, NiO₂, MnO₂, Ni_{0.33}Mn_{0.33}Co_{0.33}O₂, Ni_{0.8}Co_{0.15}Al_{0.05}O₂, or MnO₃), a material with a spinel crystal structure (e.g., Mn₂O₄ or Co₂O₄), a material with an olivine crystal structure (e.g., FePO₄, MnPO₄, or CoPO₄), and/or a material with a tavorite crystal structure (e.g., FeSO₄F or VPO₄F). In certain embodiments, the one or more chalcogenides comprises a lithiated derivative of a material with a layered crystal structure (e.g., LiTiS₂, LiCoO₂, LiNiO₂, LiMnO₂, LiNi_{0.33}Mn_{0.33}Co_{0.33}O₂, LiNi_{0.8}Co_{0.15}Al_{0.05}O₂, or Li₂MnO₃), a lithiated derivative of a material with a spinel crystal structure (e.g., LiMn₂O₄ or LiCo₂O₄), lithiated derivative of a material with an olivine crystal structure (e.g., LiFePO₄, LiMnPO₄, or LiCoPO₄), and/or a lithiated derivative of a material with a tavorite crystal structure (e.g., LiFeSO₄F or LiVPO₄F).

In certain embodiments, the one or more non-carbon, non-sulfur electroactive materials are characterized in that they have high electronic conductivity. For example, the non-carbon, non-sulfur electroactive materials have a conductivity greater than about 10⁻³ mS/cm²; greater than about 0.01 mS/cm², greater than about 0.05 mS/cm², greater than 0.1 mS/cm², greater than 0.5 mS/cm², or greater than about 1 mS/cm².

In preferred embodiments, the cathode composition does not contain carbon, or contains a low amount of carbon (e.g., no greater than 5.0 wt. %, no greater than 3.0 wt. %, no greater than 2.0 wt. %, no greater than 1.0 wt. %, no greater than 0.5 wt. %, or no greater than 0.1 wt. %). In certain embodiments, the cathode composition contains conductive materials and a binder. In certain embodiments, a conductive material comprises an electrically conductive material that facilitates movement of electrons within a composite. For example, in certain embodiments, a conductive material is selected from the group consisting of carbon-based materials, graphite-based materials, conductive polymers, metals, semiconductors, metal oxides, metal sulfides, and combinations thereof, where non-carbon materials are preferred.

In certain embodiments, a cathode further comprises a coating layer. For example, in certain embodiments, a coating layer comprises a polymer, an organic material, an inorganic material, or a mixture thereof that is not an integral part of the porous composite or the current collector.

In certain embodiments, the cathode comprises one or more of the following features: (a) a “stack” of multi-functional materials (e.g., wherein the stack comprises, for example, particles with gradient structures that balance the transport of ions and electrons for improved power capability, energy density, and life; bi-functional cathode additives that simultaneously store Li and conduct electrons, replacing expensive and space-wasting carbons; a binding molecule that spatially constrains the electrochemical reaction storing the energy and thereby extends life; electrolyte components that improve the basic efficiency of the electrolyte, providing improved energy density; and/or a cathode design that enables greater safety and energy density); (b) a tight electrode layer; (c) a tight tertiary structure; (d) porosity control; (e) a core-shell structure; (f) a cross-linked polymer shell; (g) a self-doped polymer shell; (h) an ion conductive binder; (i) a dual layer hybrid cathode; (j) a polymer that traps polysulfide; (k) a three-dimensional structure with high surface area (e.g., to hold both carbon and lithium, e.g., to intercalate); and (l) a three-dimensional structure within which carbon is replaced with a metal disulfide (e.g., and wherein the battery comprises a polymer electrolyte for sulfur).

### Anode

In certain embodiments, a secondary sulfur battery comprises a lithium anode. A lithium anode suitable for use in lithium-sulfur cells may be used. In certain embodiments, an anode of a secondary sulfur battery comprises a negative active material selected from materials in which lithium intercalation reversibly occurs, materials that react with lithium ions to form a lithium-containing compound, metallic lithium, lithium alloys, and combinations thereof. In certain embodiments, an anode comprises metallic lithium. In certain embodiments, lithium-containing anodic compositions comprise carbon-based compounds. In certain embodiments, a carbon-based compound is selected from the group consisting of crystalline carbon, amorphous carbon, graphite, and mixtures thereof. In certain embodiments, the anode does not contain carbon, or contains a low amount of carbon (e.g., no greater than 5.0 wt. %, no greater than 3.0 wt. %, no greater than 2.0 wt. %, no greater than 1.0 wt. %, or no greater than 0.5 wt. %). In certain embodiments, a material that reacts with lithium ions to form a lithium-containing compound is selected from the group consisting of tin oxide (SnO₂), titanium nitrate, and silicon. In certain embodiments, a lithium alloy comprises an alloy of lithium with another alkali metal (e.g. sodium, potassium, rubidium or cesium). In certain embodiments, a lithium alloy comprises an alloy of lithium with a transition metal. In certain embodiments, lithium alloys include alloys of lithium and a metal selected from the group consisting of Na, K, Rb, Cs, Fr, Be, Mg, Ca, Sr, Ba, Ra, Al, Sn, In, Zn, Sm, La, and combinations thereof. In certain embodiments, a lithium alloy comprises an alloy of lithium with indium. In certain embodiments, a lithium alloy comprises an alloy of lithium with aluminum. In certain embodiments, a lithium alloy comprises an alloy of lithium with zinc. In certain embodiments, an anode comprises a lithium-silicon alloy. Examples of suitable lithium-silicon alloys include: Li₁₅Si₄, Li₁₂Si₇, Li₇Si₃, Li₁₃Si₄, and Li₂₁Si₅/Li₂₂Si₅. In certain embodiments, a lithium metal or lithium alloy is present as a composite with another material. In certain embodiments, such composites include materials such as graphite, graphene, metal sulfides or oxides, or conductive polymers.

In some embodiments, an anode is protected against redox shuttling reactions and hazardous runaway reactions by any of the methodologies reported in the art, for example, by creating a protective layer on a surface of an anode by chemical passivation or by deposition or polymerization. For example, in certain embodiments, an anode comprises an inorganic protective layer, an organic protective layer, or a mixture thereof, on a surface of lithium metal. In certain embodiments, an inorganic protective layer comprises Mg, Al, B, Sn, Pb, Cd, Si, In, Ga, lithium silicate, lithium borate, lithium phosphate, lithium phosphoronitride, lithium silicosulfide, lithium borosulfide, lithium aluminosulfide, lithium phosphosulfide, lithium fluoride or combinations thereof. In certain embodiments, an organic protective layer includes a conductive monomer, oligomer, or polymer. In certain embodiments, such polymer is selected from poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-di-yl), or combinations thereof.

Moreover, in certain embodiments, inactive sulfur material, generated from an electroactive sulfur material of a cathode, during charging and discharging of a secondary sulfur battery, attaches to an anode surface. The term “inactive sulfur”, as used herein, refers to sulfur that cannot participate in an electrochemical reaction of a cathode such that it contributes no capacity upon repeated charge/discharge cycles. In certain embodiments, inactive sulfur on an anode surface acts as a protective layer on such anode. In certain embodiments, inactive sulfur is present in the form of lithium sulfide.

It is further contemplated that the concepts of the present disclosure can be adapted for use in sodium-sulfur batteries. Such sodium-sulfur batteries comprise a sodium-based anode and an intercalation or conversion material capable of intercalating or reacting with sodium ions. Such systems are encompassed within embodiments of the present disclosure.

It is further contemplated that the present disclosure can be adapted for use in batteries constructed in an anode-free configuration. In certain embodiments, a manufactured battery or battery component has an anode-free configuration and comprises an anodic current collector (e.g. copper) and one or more of the following: (a) a thin layer of garnet, (b) a structure (e.g., a complex 3D structure) with a coating deposited by atomic layer deposition (ALD) (e.g., wherein the ALD coating comprises one or more members selected from the group consisting of lithium phosphorus oxynitride (LiPON), gamet, an oxide, perovskite, a sulphide, Li₃BO₃—Li₂CO₃ (LBCO), a sodium super ionic conductor (NASICON), and alumina); (c) a polymer (e.g., polyethylene oxide (PEO) or a block copolymer); (d) lithium phosphorus oxynitride (LiPON), and (e) a solid-electrolyte interface (SEI) layer (e.g., an artificial SEI layer formed in situ).

### Preparation of Electrodes

There are a variety of methods for manufacturing electrodes for use in a secondary sulfur battery. One such process, commonly referred to as a “wet process,” involves adding the solid cathode materials to a liquid to prepare a slurry composition. These slurries are typically in the form of a viscous liquid that is formulated to facilitate a downstream coating operation. A thorough mixing of a slurry can be important for coating and drying operations, which affect performance and quality of an electrode. Suitable mixing devices include ball mills, magnetic stirrers, sonication, planetary mixers, high speed mixers, homogenizers, universal type mixers, and static mixers. A liquid used to make a slurry can be any capable of homogeneously dispersing an active material, a binder, a conducting material, and any additives, and that is also able to be evaporated. Suitable slurry liquids include, for example, N-methylpyrrolidone, acetonitrile, methanol, ethanol, propanol, butanol, tetrahydrofuran, water, isopropyl alcohol, dimethylpyrrolidone, propylene carbonate, gamma butyrolactone and the like.

In some embodiments, a prepared composition is coated on a current collector and dried to form an electrode. Specifically, a slurry is used to coat an electrical conductor to form an electrode by evenly spreading a slurry on to a conductor, which is then, in certain embodiments, optionally roll-pressed (e.g. calendared) and/or heated as is known in the art. Generally, a matrix of an active material and conductive material are held together and on a conductor by a binder. In certain embodiments, a matrix comprises a polymer binder, such as polyvinylidene fluoride (PVDF), poly(vinylidene fluoride-co-hexafluoropropene) (PVDF/HFP), polytetrafluoroethylene (PTFE), Kynar Flex® 2801, Kynar® Powerflex LBG, Kynar® HSV 900, Teflon®, styrene butadiene rubber (SBR), polyethylene oxide (PEO), or polytetrafluoroethylene (PTFE). Alternatively or additionally, in certain embodiments, lithium salts are dispersed in a matrix to improve lithium conductivity.

In certain embodiments, a current collector is selected from the group consisting of aluminum foil, copper foil, nickel foil, stainless steel foil, titanium foil, zirconium foil, molybdenum foil, nickel foam, copper foam, carbon paper or carbon fiber sheets, polymer substrates coated with conductive metal, and/or combinations thereof.

PCT Publication Nos. WO2015/003184, WO2014/074150, and WO2013/040067, the entire disclosures of which are hereby incorporated by reference herein, describe various methods of fabricating electrodes and electrochemical cells.

### Separator

In certain embodiments, a secondary sulfur battery comprises a separator, which divides the anode and cathode and prevents direct electron conduction between them. In certain embodiments, the separator has a high lithium ion permeability. In certain embodiments, a separator is relatively less permeable to polysulfide ions dissolved in electrolyte. In certain such embodiments, a separator as a whole inhibits or restricts passage of electrolyte-soluble sulfides between anodic and cathodic portions of a battery. In certain embodiments, a separator of impermeable material is configured to allow lithium ion transport between anode and cathode of a battery during charging and discharging of a cell. In some such embodiments, a separator is porous. One or more electrolyte-permeable channels bypassing, or penetrating through apertures in, an impermeable face of a separator can be provided to allow sufficient lithium ion flux between anodic and cathodic portions of a battery.

It will be appreciated by a person skilled in the art that optimal dimensions of a separator must balance competing imperatives: maximum impedance to polysulfide migration while allowing sufficient lithium ion flux. Aside from this consideration, shape and orientation of a separator is not particularly limited, and depends in part on battery configuration. For example, in some embodiments, a separator is substantially circular in a coin-type cell, and substantially rectangular in a pouch-type cell. In some embodiments, a separator is substantially flat. However, it is not excluded that curved or other non-planar configurations may be used.

A separator may be of any suitable thickness. In order to maximize energy density of a battery, it is generally preferred that a separator is as thin and light as possible. However, a separator should be thick enough to provide sufficient mechanical robustness and to ensure suitable electrical separation of the electrodes. In certain embodiments, a separator has a thickness of from about 1 μm to about 200 μm, preferably from about 5 μm to about 100 μm, more preferably from about 10 μm to about 30 μm.

### Electrolyte

In certain embodiments, a secondary sulfur battery comprises an electrolyte comprising an electrolytic salt. Examples of electrolytic salts include, for example, lithium trifluoromethane sulfonimide, lithium triflate, lithium perchlorate, LiPF₆, LiBF₄, tetraalkylammonium salts (e.g. tetrabutylammonium tetrafluoroborate, TBABF₄), liquid state salts at room temperature (e.g. imidazolium salts, such as 1-ethyl-3-methylimidazolium bis-(perfluoroethyl sulfonyl)imide, EMIBeti), and the like.

In certain embodiments, an electrolyte comprises one or more alkali metal salts. In certain embodiments, such salts comprise lithium salts, such as LiCF₃SO₃, LiClO₄, LiNO₃, LiPF₆, LiBr, LiTDI, LiFSI, and LiTFSI, or combinations thereof. In certain embodiments, an electrolyte comprises ionic liquids, such as 1-ethyl-3-methylimidzaolium-TFSI, N-butyl-N-methyl-piperidinium-TFSI, N-methyl-n-butyl pyrrolidinium-TFSI, and N-methyl-N-propylpiperidinium-TFSI, or combinations thereof. In certain embodiments, an electrolyte comprises superionic conductors, such as sulfides, oxides, and phosphates, for example, phosphorous pentasulfide, or combinations thereof.

In certain embodiments, an electrolyte is a liquid. For example, in certain embodiments, an electrolyte comprises an organic solvent. In certain embodiments, an electrolyte comprises only one organic solvent. In some embodiments, an electrolyte comprises a mixture of two or more organic solvents. In certain embodiments, a mixture of organic solvents comprising one or more weak polar solvents, strong polar solvents, and lithium protecting solvents.

The term “weak polar solvent”, as used herein, is defined as a solvent that is capable of dissolving elemental sulfur and has a dielectric coefficient of less than 15. A weak polar solvent is selected from aryl compounds, bicyclic ethers, and acyclic carbonate compounds. Examples of weak polar solvents include xylene, dimethoxyethane, 2-methyltetrahydrofuran, diethyl carbonate, dimethyl carbonate, toluene, dimethyl ether, diethyl ether, diglyme, tetraglyme, and the like. The term “strong polar solvent”, as used herein, is defined as a solvent that is capable of dissolving lithium polysulfide and has a dielectric coefficient of more than 15. A strong polar solvent is selected from bicyclic carbonate compounds, sulfoxide compounds, lactone compounds, ketone compounds, ester compounds, sulfate compounds, and sulfite compounds. Examples of strong polar solvents include hexamethyl phosphoric triamide, γ-butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, ethylene glycol sulfite, and the like. The term “lithium protection solvent”, as used herein, is defined as a solvent that forms a good protective layer, i.e. a stable solid-electrolyte interface (SEI) layer, on a lithium surface, and which shows a cyclic efficiency of at least 50%. A lithium protection solvent is selected from saturated ether compounds, unsaturated ether compounds, and heterocyclic compounds including one or more heteroatoms selected from the group consisting of N, O, and/or S. Examples of lithium protection solvents include tetrahydrofuran, 1,3-dioxolane, 3,5-dimethylisoxazole, 2,5-dimethyl furan, furan, 2-methyl furan, 1,4-oxane, 4-methyldioxolane, and the like.

In certain embodiments, an electrolyte is a liquid (e.g., an organic solvent). In some embodiments, a liquid is selected from the group consisting of organocarbonates, ethers, sulfones, water, alcohols, fluorocarbons, or combinations of any of these. In certain embodiments, an electrolyte comprises an ethereal solvent.

In certain embodiments, an organic solvent comprises an ether. In certain embodiments, an organic solvent is selected from the group consisting of 1,3-dioxolane, dimethoxyethane, diglyme, triglyme, γ-butyrolactone, γ-valerolactone, and combinations thereof. In certain embodiments, an organic solvent comprises a mixture of 1,3-dioxolane and dimethoxyethane. In certain embodiments, an organic solvent comprises a 1:1 v/v mixture of 1,3-dioxolane and dimethoxyethane. In certain embodiments, an organic solvent is selected from the group consisting of: diglyme, triglyme, γ-butyrolactone, γ-valerolactone, and combinations thereof. In certain embodiments, an electrolyte comprises sulfolane, sulfolene, dimethyl sulfone, methyl ethyl sulfone, or a combination thereof. In some embodiments, an electrolyte comprises ethylene carbonate, propylene carbonate, dimethyl carbonate, diethyl carbonate, methylethyl carbonate, or a combination thereof.

In certain embodiments, an electrolyte is a solid. In certain embodiments, a solid electrolyte comprises a polymer. In certain embodiments, a solid electrolyte comprises a glass, a ceramic, an inorganic composite, or combinations thereof. In certain embodiments, a solid electrolyte comprises a polymer composite with a glass, a ceramic, an inorganic composite, or combinations thereof. In certain embodiments, such solid electrolytes comprise one or more liquid components as plasticizers or to form a “gel electrolyte”.

### Secondary Sulfur Battery

Described herein are secondary sulfur batteries comprising cathode compositions described above. For example, in certain embodiments, such batteries include a lithium-containing anode composition coupled to the provided cathode composition by a lithium conducting electrolyte. In some embodiments, such batteries also comprise additional components such as separators between the anode and cathode, anodic and cathodic current collectors, terminals by which a cell can be coupled to an external load, and packaging such as a flexible pouch or a rigid metal container. It is further contemplated that the present disclosure regarding secondary sulfur batteries can be adapted for use in sodium-sulfur batteries, and such batteries are also considered within the scope of certain embodiments of the present disclosure.

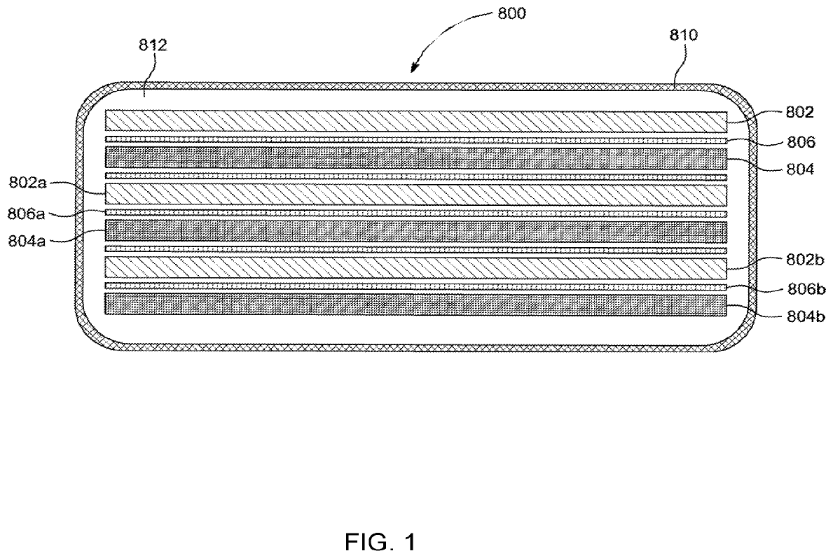

FIG. 1 illustrates a cross section of an electrochemical cell 800 in accordance with exemplary embodiments of the disclosure. Electrochemical cell 800 includes a negative electrode 802, a positive electrode 804, a separator 806 interposed between negative electrode 802 and positive electrode 804, a container 810, and a fluid electrolyte 812 in contact with negative and positive electrodes 802, 804. Such cells optionally include additional layers of electrode and separators 802a, 802b, 804a, 804b, 806a, and 806b.

Negative electrode 802 (also sometimes referred to herein as an anode) comprises a negative electrode active material that can accept cations. Non-limiting examples of negative electrode active materials for lithium-based electrochemical cells include Li metal, Li alloys such as those of Si, Sn, Bi, In, and/or Al alloys, Li₄Ti₅O₁₂, hard carbon, graphitic carbon, metal chalcogenides, and/or amorphous carbon. In accordance with some embodiments of the disclosure, most (e.g., greater than 90 wt %) of an anode active material can be initially included in a discharged positive electrode 804 (also sometimes referred to herein as a cathode) when electrochemical cell 800 is initially made, so that an electrode active material forms part of first electrode 802 during a first charge of electrochemical cell 800.

A technique for depositing electroactive material on a portion of negative electrode 802 is described in U.S. Patent Publication Nos. 2016/0172660 and 2016/0172661, in the name of Fischer et al., the contents of each of which are hereby incorporated herein by reference, to the extent such contents do not conflict with the present disclosure.

Positive electrode 804 (also referred to herein as cathode) comprises a cathode composition as described herein. In certain embodiments, the cathode composition comprises about 30 to about 70 wt % electroactive sulfur. In certain embodiments, a cathode comprises at least about 70% of total sulfur present in an electrochemical cell. In certain embodiments, a cathode comprises at least about 80% of total sulfur present in an electrochemical cell. In certain embodiments, a cathode comprises at least about 90% of total sulfur present in an electrochemical cell. In certain embodiments, a cathode comprises at least about 95% of total sulfur present in an electrochemical cell. In certain embodiments, a cathode comprises at least about 99% of total sulfur present in an electrochemical cell. In certain embodiments, a cathode comprises essentially all of the total sulfur present in an electrochemical cell.

Negative electrode 802 and positive electrode 804 can further include one or more electrically conductive additives as described herein. In accordance with some embodiments of the disclosure, negative electrode 802 and/or positive electrode 804 further include one or more polymer binders as described herein.

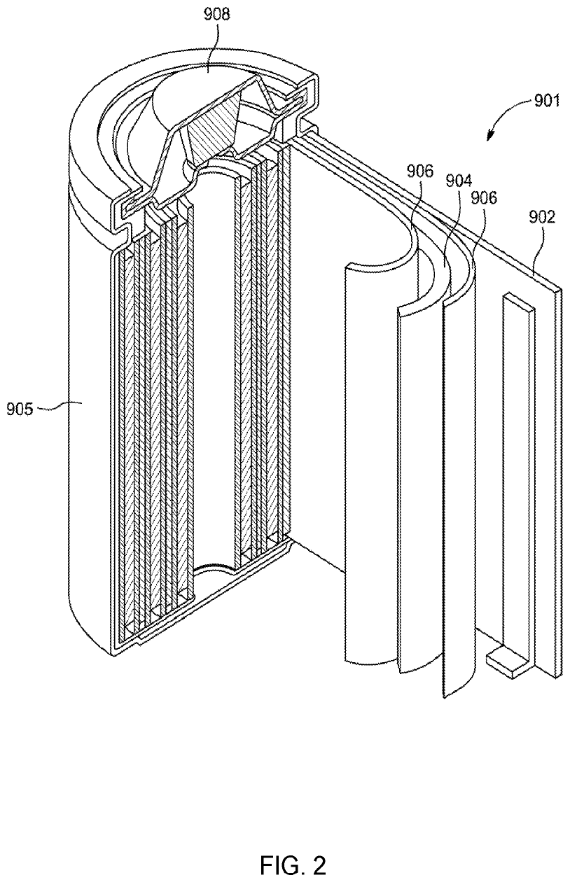

FIG. 2 illustrates an example of a battery according to various embodiments described herein. A cylindrical battery is shown here for illustration purposes, but other types of arrangements, including prismatic or pouch (laminate-type) batteries, may also be used as desired. Example Li battery 901 includes a negative anode 902, a positive cathode 904, a separator 906 interposed between the anode 902 and the cathode 904, an electrolyte (not shown) impregnating the separator 906, a battery case 905, and a sealing member 908 sealing the battery case 905. It will be appreciated that example battery 901 may simultaneously embody multiple aspects of the present disclosure in various designs.

A secondary sulfur battery of the present disclosure comprises a lithium anode, a porous sulfur-based cathode, and an electrolyte permitting lithium ion transport between anode and cathode. In certain embodiments, described herein, an anodic portion of a battery comprises an anode and a portion of electrolyte with which it is in contact. Similarly, in certain embodiments, described herein, a cathodic portion of a battery comprises a cathode and a portion of electrolyte with which it is in contact. In certain embodiments, a battery comprises a lithium ion-permeable separator, which defines a boundary between an anodic portion and a cathodic portion. In certain embodiments, a battery comprises a case, which encloses both anodic and cathodic portions. In certain embodiments, a battery case comprises an electrically conductive anodic-end cover in electrical communication with an anode, and an electrically conductive cathodic-end cover in electrical communication with a cathode to facilitate charging and discharging via an external circuit.

In certain embodiments, a secondary sulfur battery of the present disclosure is defined in terms of its ratio of electrolyte to electroactive sulfur. Electrolyte volume and the ratio (vol/wt) of electrolyte to sulfur in a cathode correlate to energy density of a sulfur battery. Electrolyte may be distributed among different volumes within a cell, for example electrolyte may be contained in porosity of the cathode, in the separator, and in contact with the anode or within an anodic solid electrolyte interphase. Electrolyte may also be contained in other spaces within a battery where it is not in direct contact with the anodic or cathodic active materials—for example electrolyte may be stranded in an annular volume at the edges of a coin cell. In certain embodiments, the present invention provides batteries where all or most of the electrolyte is contained within the cathode. Preferably, substantially all of the electrolyte is contained within the cathode and only a minimal amount of electrolyte that is necessary to wet the separator and the anode surface or SEI is outside of the cathode. Electrolyte contained within the cathode is referred to as “contained electrolyte” and its volume WE can be estimated as theoretical pore volume, or porosity multiplied by the geometric volume of a cathode film:

$${V}_{CE} = P \% \times Area \times {thickness}_{cathode}$$

In certain embodiments, a provided secondary sulfur battery is characterized in that at least 50% of the total electrolyte inventory (Vₜₒₜ) is contained in the cathode (e.g. V_{CE}/Vₜₒₜ>0.5). In certain embodiments, a provided secondary sulfur battery is characterized in that at least 50% of the total electrolyte inventory (Vₜₒₜ) is contained in the cathode (e.g. V_{CE}/Vₜₒₜ>0.8). In certain embodiments, a secondary sulfur battery has at least 60%, at least 65%, or at least 70% of the electrolyte contained in the cathode porosity. In certain embodiments, a secondary sulfur battery has at least 80%, at least 85%, or at least 90%, of the electrolyte contained in the cathode porosity. In certain embodiments, a secondary sulfur battery has at least 92%, at least 94%, at least 95%, at least 96%, or at least 97% of the electrolyte contained in the cathode.

The ratio of total electrolyte-to-sulfur (E/S) is another parameter that influences the energy density of a battery. The E/S ratio is calculated based on the total volume of electrolyte Vₜₒₜ and the mass of electroactive sulfur (m_{sulfur}):

$$\frac{E}{S} = \frac{{V}_{tot}}{{m}_{sulfur}}$$

In certain embodiments, a secondary sulfur battery has an electrolyte-to-sulfur ratio equal to or less than about 6 microliters of electrolyte per milligram of electroactive sulfur. In certain embodiments, a secondary sulfur battery has an electrolyte-to-sulfur ratio equal to or less than about 5 microliters of electrolyte per milligram of electroactive sulfur. In certain embodiments, a secondary sulfur battery has an electrolyte-to-sulfur ratio equal to or less than about 4.5 microliters of electrolyte per milligram of electroactive sulfur. In certain embodiments, a secondary sulfur battery has an electrolyte-to-sulfur ratio equal to or less than about 3.5 microliters of electrolyte per milligram of electroactive sulfur or less than about 3.0 microliters of electrolyte per milligram of electroactive sulfur. In certain embodiments, a secondary sulfur battery has an electrolyte-to-sulfur ratio equal to or less than about 3.5 microliters of electrolyte per milligram of electroactive sulfur. In certain embodiments, a secondary sulfur battery has an electrolyte-to-sulfur ratio equal to or less than about 3 microliters of electrolyte per milligram of electroactive sulfur. In certain embodiments, a secondary sulfur battery has an electrolyte-to-sulfur ratio between about 1.8 and about 3.5 μL/mg S. In certain embodiments, a secondary sulfur battery has an electrolyte-to-sulfur ratio between about 1.8 and about 2.5 μL/mg S. In certain embodiments, a secondary sulfur battery has an electrolyte-to-sulfur ratio between about 1.0 and about 2.0 μL/mg S. In certain embodiments, a secondary sulfur battery has an electrolyte-to-sulfur ratio between about 1.5 and about 2.0 μL/mg S.

### EQUIVALENTS

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

What is claimed is:

1. A cathode material for a carbon-free sulfur cathode, the cathode material comprising:
at least one electroactive sulfur conversion cathode material; and
a non-sulfur, non-carbon electroactive material,
wherein the cathode material (e.g., and wherein the carbon-free cathode) contains no more than 5 wt. % (e.g., no more than 2 wt. %, no more than 1 wt. %, no more than 0.5 wt. %, or no more than 0.1 wt. %) carbon.

2. The cathode material of claim 1, wherein the non-sulfur, non-carbon electroactive material is an intercalation material having a structure capable of reversibly intercalating lithium ions within a voltage range overlapping with the voltage range of sulfur conversion (e.g., from about 1.8 V to about 2.6 V, vs. Li/Li⁺ e.g., from about 2.0 V to about 2.4 V vs. Li/Li⁺).

3. The cathode material of claim 1, wherein the non-sulfur, non-carbon electroactive material is a conversion material (e.g., a chalcogenide that undergoes an electrochemical conversion reaction within a voltage range overlapping with the voltage range of sulfur conversion (e.g., from about 1.8 V to about 2.6 V, vs. Li/Li⁺ e.g., from about 2.0 V to about 2.4 V vs. Li/Li⁺).

4. The cathode material of any one of the preceding claims, wherein the non-sulfur, non-carbon electroactive material is a chalcogenide (e.g., a metal chalcogenide, e.g., a metal sulfide).

5. The cathode material of any one of the preceding claims, wherein the non-sulfur, non-carbon electroactive material is also an electron conductor.

6. The cathode of any one of the preceding claims, wherein the non-sulfur, non-carbon electroactive material has discharge capacity.

7. The cathode material of any one of the preceding claims, comprising core shell structures.

8. The cathode material of claim 7 comprising cores each having a surrounding shell, said cores comprising the electroactive sulfur conversion material (e.g., Li₂S₂ and/or Li₂S), and said shells comprising the non-sulfur, non-carbon electroactive material (e.g., one or more metal chalcogenides).

9. The cathode material of claim 7 or 8, wherein the core shell structures have an average core diameter in a range from 50 to 300 nm, and an average shell thickness in a range from 1 to 20 nm thick (e.g., no greater than 10 nm thick).

10. The cathode material of any one of claims 7 to 9, wherein the core shell structures have at least 10 mass % non-sulfur non-carbon electroactive material (e.g., metal chalcogenide) relative to sulfur (e.g., from 10 to 90 mass % non-sulfur, non-carbon electroactive material, e.g., from 30 to 70 mass % non-sulfur, non-carbon electroactive material).

11. The cathode material of any one of the preceding claims, wherein the at least one electroactive sulfur conversion cathode material comprises one or more members selected from the group consisting of: sulfur in its S₈ cyclic octatonic molecular form, lithium sulfide (e.g., Li₂S₂ and/or Li₂S), an electroactive organosulfur compound, and an electroactive sulfur containing polymer.

12. A cathode comprising the cathode material of any one of claims 1 to 11, wherein the fraction of carbon in the cathode is no more than 5 wt % (e.g., no more than 2 wt %, no more than 1 wt %, no more than 0.5 wt %, or no more than 0.1 wt %).

13. The cathode of claim 12, wherein the cathode material is disposed in a film (e.g., that comprises a binder).

14. A battery (e.g., a rechargeable battery) comprising (i) the cathode of claim 12 or claim 13 and (ii) an electrolyte in contact with the cathode.

15. The battery of claim 14, further comprising an anode.

16. The battery of claim 15, wherein the anode is a protected lithium metal anode.

17. The battery of claim 14, further comprising a protected current collector.
